(19) United States
(12) Patent Application Publication
(10) Pub. No.: US 2009/0265525 A1
(43) Pub. Date: Oct. 22, 2009

(54) DETERMINING MEMORY UPGRADE OPTIONS

(75) Inventor: Paul Petersen, Boise, ID (US)

Correspondence Address: FLETCHER YODER (MICRON TECHNOLOGY, INC.), P.O. BOX 692289, HOUSTON, TX, 77269-2289, US

(73) Assignee: Micron Technology, Inc., Boise, ID (US)

(21) Appl. No.: 12/494,000

(22) Filed: Jun. 29, 2009

Related U.S. Application Data
(63) Continuation of application No. 09/419,523, filed on Oct. 18, 1999.

(51) Int. Cl. G06F 12/02; G06F 12/00

(52) U.S. Cl. 711/170; 711/E12.001; 711/E12.002

(57) ABSTRACT

A method to determine memory/upgrade options retrieves memory configuration data from a non-volatile storage element associated with system memory modules, determine the total memory capacity of the computer system, determines a residual memory capacity based on the prior obtained information, and presents the user with a series of options to upgrade existing system memory or replace one or more currently installed memory modules.

### CROSS-REFERENCE TO RELATED APPLICATION

This application is a continuation of U.S. patent application Ser. No. 09/419,523, which was filed on Oct. 18, 1999.

### BACKGROUND

The invention relates generally to computer system memory and more particularly to upgrading computer system main memory.

As computer technology has progressed, vast improvements have been made in overall system performance. Developments in areas such as high speed microprocessors, graphics subsystems, and system memory have been fundamental to increases in computer system performance. Enhancements in memory technology include the development of memory having faster access. In addition, computer architectures have been enhanced to allow more system memory to be utilized. In conjunction with the improvements in memory technology, the price of memory has generally decreased over time, making high performance memory more affordable to computer users.

Therefore, computer users often desire to upgrade their computer systems with more memory or memory having better performance characteristics. Unfortunately, the memory upgrade process may be complicated, requiring specialized knowledge of memory technologies. A user may have to determine the memory capacity of their computer system and characteristics of the memory currently installed in their computer in order to upgrade properly. Thus, it would be beneficial to provide users with system memory upgrade information and options.

### SUMMARY

In one embodiment, the invention provides a method to provide memory upgrade information. The method includes obtaining memory configuration information of a computer system, determining a memory capacity of the computer system and determining memory upgrade options based on the computer system's residual memory capacity. Alternatively, the method may be embodied in instructions stored on a program storage device that is readable by a programmable control device. In another embodiment, the programmable storage device which includes instructions of the method may be included in a computer system having a memory configuration routine in accordance with the invention.

### BRIEF DESCRIPTION OF THE DRAWINGS

FIG. 1 shows an illustrative computer system having a memory configuration routine in accordance with one embodiment of the invention.

FIG. 2 shows an ancillary bus to communicate with system memory configuration storage media in accordance with another embodiment of the invention.

FIG. 3 shows a flow diagram for a memory configuration routine in accordance with yet another embodiment of the invention.

### DETAILED DESCRIPTION

Techniques (including methods and devices) are described to determine a memory configuration of a computer system and provide memory upgrade options to a user. The following embodiments of this invention are illustrative only and are not to be considered limiting in any respect.

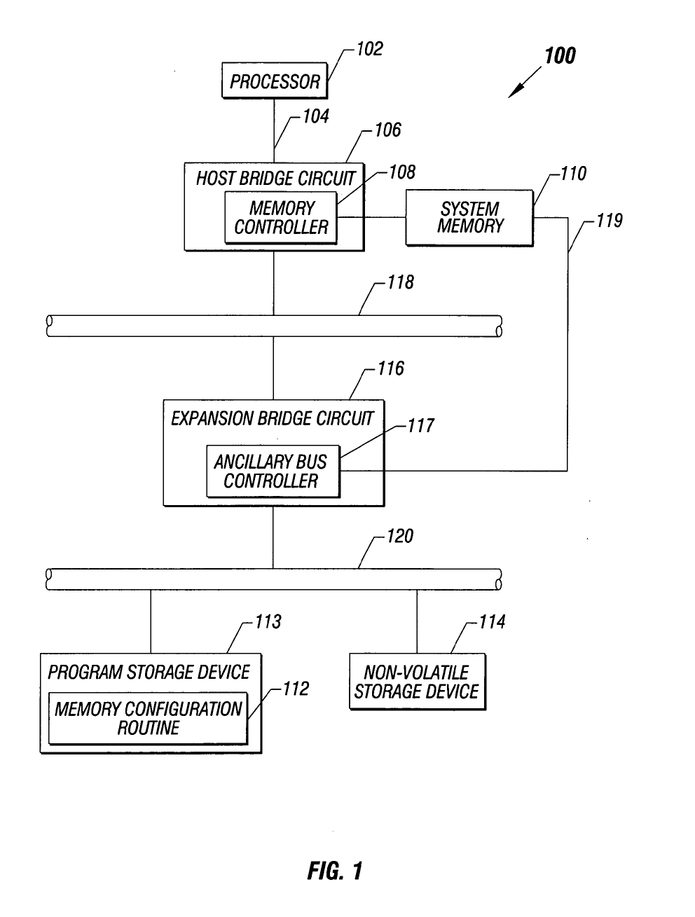

Referring to FIG. 1, an illustrative computer system 100 in accordance with the invention includes a memory configuration routine 112 to determine characteristics of system memory 110 and provide this information to a user in anticipation of a memory upgrade. The routine 112 determines the memory address characteristics of the system 100 (e.g., maximum address space of a processor operating system and/or number of memory sockets available for connecting memory). The routine 112 also identifies a current memory configuration including the operational characteristics of installed memory. Using this combination of information, the routine 222 calculates a residual memory capacity and provides memory upgrade options to a user. Illustrative operational characteristics include, but are not limited to, the type of memory, the operating speed of the memory, the size or capacity of the memory, and the organization (i.e., bank layout) of the memory.

As shown, the system 100 may also include a processor 102 coupled to a host bridge circuit 106 through a processor bus 104. The host bridge circuit 106 (such as the 82443BX Host-to-PCI bridge device from Intel Corporation) may facilitate communication between the processor 102 and various other system devices, including system memory 110. A memory controller 108 may be included in the host bridge circuit 106 to control access to the system memory 110. When the processor 102 or another device of the system 100 requires access to the system memory 110, the memory controller 108 must be activated.

The host bridge circuit 106 may be coupled to a primary bus 118 which operates in conformance with, for example, the Peripheral Component Interconnect (PCI) standard. An expansion bridge circuit 116, (such as the 82371AB PIIX4 IDE controller from Intel Corporation) allows communication between the primary bus 118 and a secondary bus 120. The secondary bus 120 may be operated in conformance with the Industry Standard Architecture (ISA), Extended Industry Standard Architecture (EISA), or the Low Pin Count (LPC) standards.

An ancillary bus controller 117 provides a communication interface for retrieval of configuration information from system memory over an ancillary bus 119. Illustrative ancillary busses include those operated in conformance with the System Management Bus (sponsored by Intel Corporation) or the 12C bus (sponsored by Philips Semiconductors). In one embodiment of the invention, the ancillary bus controller 117 may be incorporated within the expansion bridge circuit 116 as shown in FIG. 1. In another embodiment, the ancillary bus controller 117 may be incorporated in the host bridge circuit 106. In yet another embodiment, the ancillary bus controller 117 may be incorporated in a stand alone device coupled to primary bus 118 or secondary bus 120.

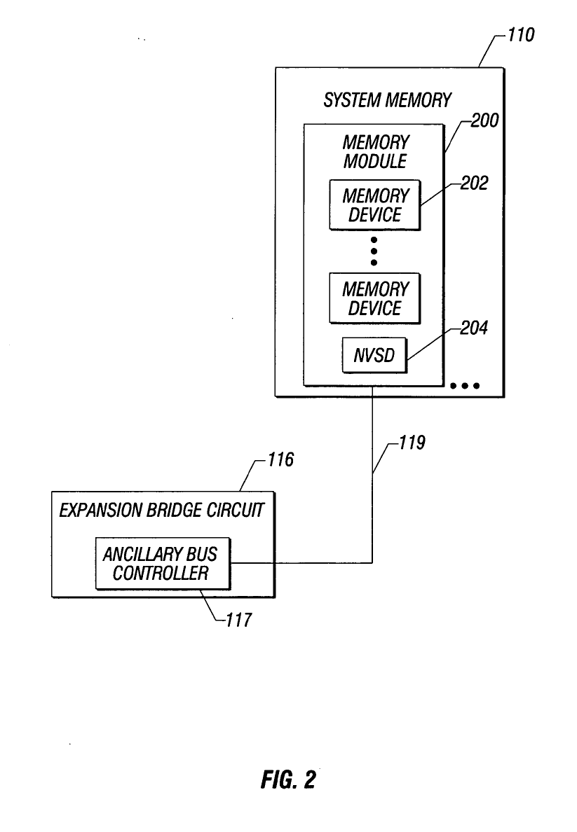

Referring to FIG. 2, the system memory 110 may include one or more memory modules 200, each having multiple dynamic random access memory (DRAM) devices 202 and a non-volatile storage device (NVSD) 204 such as a serial presence detect (SPD) device. A memory module 200 may be a detachable device that is coupled to the system 100 through sockets which are coupled to the memory controller 110. Memory devices 202 may be arranged on the memory module 200 to provide random access memory (RAM) storage for the processor 102 and other devices of the system 100. The memory devices 202 may be any type of DRAM such as fast page mode (FPM) DRAM, extended data out (EDO) DRAM, synchronous DRAM (SDRAM), double data rate (DDR) DRAM, Synchlink DRAM (SLDRAM), or RAMBUS DRAM (RDRAM). The non-volatile storage device 204 located on each memory module 200 may be any type of non-volatile storage, such as erasable programmable read only memory (EPROM) or electrically erasable programmable read only memory (EEPROM), that stores information about the type and operating characteristics of the memory on the module 200. Such operational characteristics include information about the memory devices 202 speed, the total amount of memory on the memory module 200, the organization of the memory (e.g., number and size of banks) and manufacturer identification data. The ancillary bus controller 117 may query the non-volatile storage device 204 of each memory module 200 via the ancillary bus 119 to retrieve memory configuration data to be used by the memory configuration routine 112 in determining memory upgrade options.

Referring again to FIG. 1, the memory configuration routine 112 may be stored as an executable code segment on a program storage device 113. The device 113 may be any suitable storage media such as a magnetic hard or floppy disk drive, an optical disk drive or boot read-only memory (ROM). The memory configuration routine 112 may be provided by an original equipment manufacturer (OEM) as a utility or application that may be accessed in the same manner as conventional applications. For example, a user may launch the memory configuration routine 112 by selecting an icon or by entering text at a command prompt.

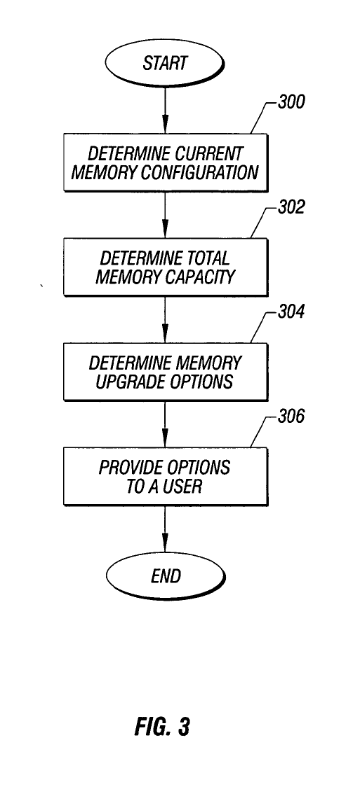

Referring to FIG. 3, the memory configuration routine 112 obtains configuration data such the type, amount, and operating characteristics of memory present in system memory 110 (block 300). In one embodiment, the routine 112 may use the ancillary bus controller 117 to retrieve configuration data for currently installed memory modules 200 by querying each module's non-volatile storage device 204. In another embodiment, configuration data for each memory module 200 may stored in a non-volatile storage device 114 (see FIG. 1) when memory controller 110 is initialized during power on self test (POST) operations. Configuration data so stored may be retrieved by the routine 112. In yet another embodiment, the memory configuration routine 112 may retrieve memory configuration data form configuration registers internal to or associated with the memory controller 110 (not shown in FIG. 1).

As shown in block 302, the memory configuration routine 112 also determines a total memory capacity for the system 100 by identifying the number of memory module sockets available and/or the number of address lines utilized by the memory controller 108. In one embodiment, basic input/output system (BIOS) routines may be used to acquire information regarding total memory capacity. Alternatively, this information may be readily available on a non-volatile storage device such as device 114 (see FIG. 1).

In determining the total memory capacity, the memory configuration routine 112 may also account for limitations of a specific memory type already in use in the system 100. Configuration data from non-volatile storage device 204 may be utilized to determine constraints for a particular type of memory device 202. For example, if the system memory 110 comprises RAMBUS devices, there is a limit of 32 devices per memory channel (i.e., memory devices 202). An additional limitation is that a RAMBUS memory controller 108 may only support three memory module sockets. (A RAMBUS technology overview may be obtained from Rambus, Inc. of California.) The precise constraints vary based on the type of memory device, but will be well known to those of ordinary skill in the art of computer system memory design.

After determining both the total memory capacity and the current memory configuration of the system 100, the memory configuration routine 112 determines memory upgrade options at block 304. For example, by contrasting the current memory configuration with the total memory capacity, the routine 112 may determine a residual memory capacity. The routine 112 may determine options to upgrade memory by adding memory modules of the same or a compatible memory type up to the limits of the residual memory capacity. The memory configuration routine 112 may also determine options to replace existing memory modules 200 with other types of memory or with memory modules having a greater amount of memory. The options established by the routine 112 may be based on specifications of memory modules currently available through memory manufacturers. This information may be stored on the non-volatile storage device 204 or in one or more data files accessible to routine 112. Alternatively, or in addition, this information may be obtained by routine 112 via an internet connection (directly or via modem).

Each of the possible upgrade options may be provided to a user, as shown at block 306, using any available output method such as a text listing of the options or a dialog box with upgrade information. In accordance with another embodiment, a user may be provided with an interactive interface to the memory configuration routine 112 wherein the user may be given the opportunity to select an indication of a particular memory module as an upgrade option. In response, the routine 112 may calculate new upgrade options or memory replacement options based on the user's selections. In this and similar embodiments, a user may explore many upgrade options and make an informed decision when upgrading system memory.

While the invention has been disclosed with respect to a limited number of embodiments, numerous modifications and variations will be appreciated by those skilled in the art. For example, the acts of blocks 300 and 302 may be performed in reverse order (i.e., 302 followed by 300). It is intended, therefore, that the following claims cover all such modifications and variations that may fall within the true spirit and scope of the invention.

1. A method to provide memory upgrade information comprising:
determining a current memory configuration of a computer system, wherein the current memory configuration comprises configuration data for memory modules currently installed in the computer system;
determining a total memory capacity for the computer system, wherein the total memory capacity is a maximum amount of memory that may be installed in the computer system as limited by aspects of the computer system and aspects of the memory modules;
determining memory upgrade options for the computer system, wherein the memory upgrade options are based on the current memory configuration and the total memory capacity; and
providing the memory upgrade options to a user.

2. The method of claim 1, wherein determining the current memory configuration comprises accessing a non-volatile storage device on each of the memory modules.

3. The method of claim 1, wherein the configuration data for memory modules currently installed in the computer system includes an operating speed of the memory modules.

4. The method of claim 1, wherein the configuration data for memory modules currently installed in the computer system includes a size of the memory modules.

5. The method of claim 1, wherein the configuration data for memory modules currently installed in the computer system includes an organization or layout of the memory modules.

6. The method of claim 1, wherein the configuration data for memory modules currently installed in the computer system includes a type of technology standard utilized by the memory modules.

7. The method of claim 1, wherein the current memory configuration of the computer system is stored in a non-volatile storage device by the computer system.

8. The method of claim 1, wherein the aspects of the computer system include a maximum number of physical memory module sockets on the computer system.

9. The method of claim 1, wherein the aspects of the computer system include a maximum number of address lines utilized by the computer system.

10. The method of claim 1, wherein the aspects of the memory modules include constraints on a type of technology standard utilized by the memory modules.

11. The method of claim 1, wherein the total memory capacity for the computer system is stored in a non-volatile storage device by the computer system.

12. The method of claim 1, wherein determining memory upgrade options for the computer system comprises determining a residual memory capacity and determining configuration data for new memory modules.

13. The method of claim 12, wherein the memory upgrade options further comprise adding the new memory modules to the computer system.

14. The method of claim 12, wherein the memory upgrade options further comprise replacing the memory modules currently installed in the computer system with new memory modules.

15. The method of claim 12, wherein the configuration data for the new memory modules is obtained from sources outside of the computer system.

16. The method of claim 1, wherein providing the memory upgrade options to the user comprises an interactive interface wherein the user may select a memory upgrade option and be presented with new memory upgrade options based on the selection.

17. A computer system comprising:
a processor;
system memory electronically coupled to the processor, wherein the system memory comprises one or more memory modules currently installed in the computer system; and
computer-readable media comprising a computer program product, the computer program product storing a configuration routine including instructions to determine a current memory configuration, determine a total memory capacity, and determine memory upgrade options, wherein the instructions to determine the total memory capacity comprise instructions to determine a maximum amount of memory that may be installed in the computer system as limited by aspects of the computer system and aspects of the memory modules.

18. The computer system of claim 17, wherein the instructions to determine the current memory configuration comprise instructions to determine configuration data for the memory modules currently installed in the computer system.

19. The computer system of claim 17, wherein the instructions to determine memory upgrade options comprise instructions to determine memory upgrade options based on the current memory configuration and the total memory capacity.

20. The computer system of claim 17, wherein the configuration routine is further configured to include instructions to provide the memory upgrade options to a user.

21. A computer-readable media comprising:
a computer program product, the computer program product storing a configuration routine including instructions to determine a current memory configuration, determine a total memory capacity, and determine memory upgrade options, wherein the instructions to determine the total memory capacity comprise instructions to determine a maximum amount of memory that may be installed in the computer system as limited by aspects of the computer system and aspects of the memory modules.
